(19) United States
(12) Patent Application Publication
(10) Pub. No.: US 2024/0116359 A1
(43) Pub. Date: Apr. 11, 2024

(54) WORKING MACHINE WITH MODULARIZED ELECTRIC ACCESSORIES

(71) Applicant: Kubota Corporation, Osaka (JP)

(72) Inventors: Joshua M. Gattis, Fort Worth, TX (US); Gerald Johnson, Fort Worth, TX (US)

(73) Assignee: Kubota Corporation, Osaka (JP)

(21) Appl. No.: 18/478,902

(22) Filed: Sep. 29, 2023

Related U.S. Application Data
(60) Provisional application No. 63/413,577, filed on Oct. 5, 2022.

(51) Int. Cl. B60K 17/28

(52) U.S. Cl. CPC B60K 17/28

(57) ABSTRACT

Some embodiments may include a working machine including a transportation system and one or more implements to perform one or more work tasks, the working machine further including: at least one selectively-locatable electric accessory, which comprises at least part of the transportation system or at least part of a powered implement of the one or more implements, the at least one selectively-locatable electric accessory defining a first mechanical frame connection; a frame assembly including two or more power points at two or more different locations on the frame assembly, respectively; wherein each power point defines a second mechanical frame connection to mate with the first mechanical frame connection, and wherein the at least one selectively-locatable electric accessory is operable in any of the two or more power points. Other embodiments may be disclosed and/or claimed.

### PRIORITY

This application is a non-provisional of U.S. Provisional Application No. 63/413,577 filed on Oct. 5, 2022, which is incorporated by reference herein.

### TECHNICAL FIELD

The present disclosure relates to off-highway working vehicles and other working machines, and some embodiments relate to a working machine with modularized electric accessories.

### BACKGROUND

Off-highway working vehicles or other working machines, which may operate on steep or uneven ground, may include utility vehicles, such as tractors, lawnmowers, construction vehicles, agriculture vehicles, mining vehicles, or the like. These working machines may have transportation systems, such as wheels, treads, walking devices, crawlers, or the like, to transport the working machine from one location to another. A motorized transportation system may be powered by any power source, such as a combustion engine, an electric motor, or the like, or combinations thereof.

In addition to the transportation system, these working machines may include tools for performing a work task, such as a residential operation, commercial operation, or industrial operation. Example work tasks may include mowing, spraying, harvesting, planting, digging, mining, leveling, or the like. These tools may also be referred to as implements, and may include:
Passive implements such as a plow that is pulled by a tractor, a trailer with a non-motorized transportation system, or the like; and
Motorized implements, such as a powered hitch to position a plow, a mower, a digger, a lawn edger, or the like.

Various components of these working machines (e.g., motorized devices of the transportation system and/or a motorized implement), may be configured to operate autonomously (e.g., fully autonomously or semi-autonomously). A robotic lawn mower is one example of a working machine that may operate fully autonomously. A tractor having an auto-steering system interfacing with the steering wheel (or steering wheel column) is one example of a semi-autonomous working vehicle (because an operator may manually steer the vehicle using the steering wheel).

### BRIEF DESCRIPTION OF THE DRAWINGS

FIG. 1A is a schematic view of a working machine including power points and modularized electric accessories coupled thereto, according to various embodiments.

FIG. 1B is a schematic view of a power point of the plurality of power points of FIG. 1A.

FIG. 1C is a schematic view of the power take off (PTO) electric accessory of the modularized working machine of FIG. 1A.

FIG. 2 is a schematic view of another power point, according to various embodiments.

FIG. 3 is a schematic view of a modularized electric accessory usable with the power point of FIG. 2.

FIG. 4 is a schematic view of a working vehicle including a tractor and a towed implement according to various embodiments, in which the working vehicle may include a plurality of power points.

FIG. 5 is a schematic view of various components of the working vehicle of FIG. 4.

FIG. 6 is a schematic view of a chassis and a transportation device for a modular drivetrain, according to various embodiments.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items. The systems, apparatus, and methods described herein should not be construed as limiting in any way. Instead, the present disclosure is directed toward all novel and non-obvious features and aspects of the various disclosed embodiments, alone and in various combinations and sub-combinations with one another. The term “or” refers to “and/or,” not “exclusive or” (unless specifically indicated).

The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation. Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus.

Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art. In some examples, values, procedures, or apparatus' are referred to as “lowest”, “best”, “minimum,” or the like. It will be appreciated that such descriptions are intended to indicate that a selection among many used functional alternatives can be made, and such selections need not be better, smaller, or otherwise preferable to other selections.

Examples are described with reference to directions indicated as “above,” “below,” “upper,” “lower,” and the like. These terms are used for convenient description, but do not imply any particular spatial orientation.

Working machines may have a wide variety of work generating mechanisms and actuation systems beyond the ground drive propulsion systems used to move the vehicle from one location to another (e.g., besides the transportation system). These mechanized systems, which may be part of one or more implements of the working machine, may accomplish working tasks such as a lifting, lowering, digging, grading cutting, grinding, clamping, loading, etc. The mechanized systems may accomplish these work tasks using linear actuators (e.g., hydraulic cylinders), power take off (PTO) (e.g., gear driven power transmission to a rotating shaft), and the like, or combinations thereof.

For machines powered exclusively by internal combustion engines (ICEs), transferring power through a rotational shaft is the genesis of power distribution. The rotational power distribution can then be converted to other forms using additional mechanical transmissions, hydraulics, and/or electrical components.

In the case of working machines with full electric transportation systems and/or powertrains (e.g., pure electric vehicles (EVs) or other pure electric working machines), power distribution options may be governed by fewer mechanical constraints when compared to ICE machines. Electric working machine designs may lend themselves to increased flexibility with regard to machine configuration and optimization for specific work tasks. Due to the cost of certain electrified working machine components like electric motors and actuators, compared to certain mechanical systems used with ICEs, leveraging electric working machine platform flexibility to modular drivetrain components into on-demand configuration is desirable.

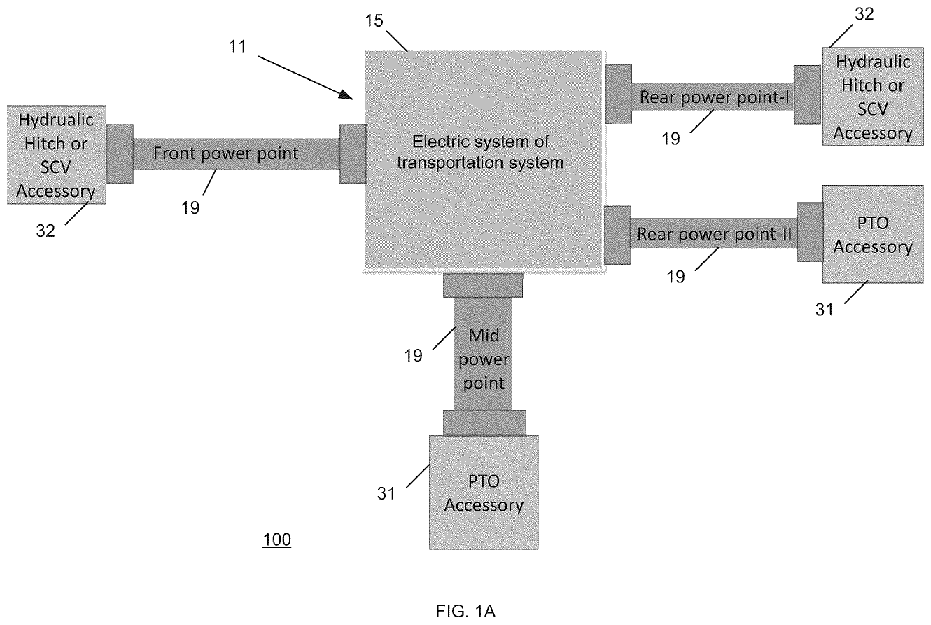

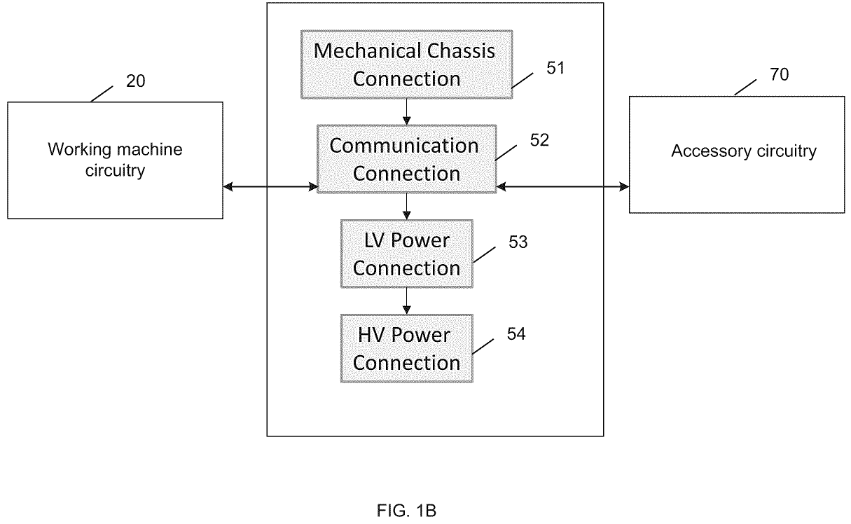

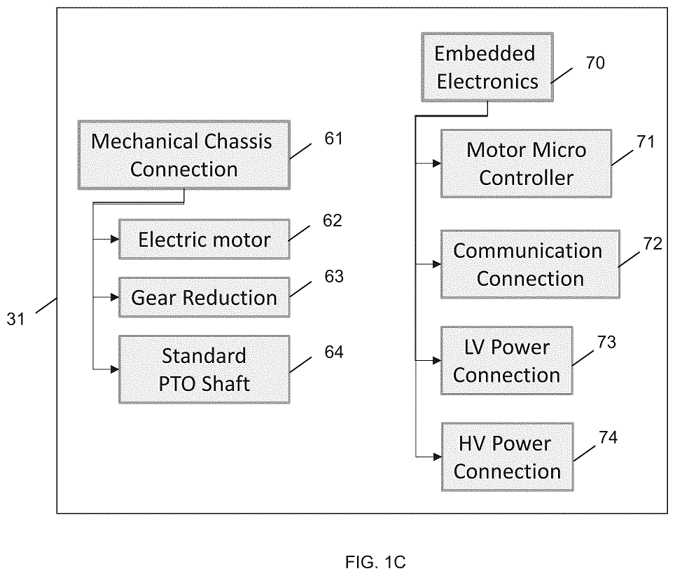

FIG. 1A is a schematic view of a working machine 100 including power points 19 and modularized electric accessories 31 and 32 coupled thereto, according to various embodiments. FIG. 1B is a schematic view of a power point 19 of the power points 19 of FIG. 1A. FIG. 1C is a schematic view of the power take off (PTO) electric accessory 31 of the modularized working machine 100 of FIG. 1A.

Referring now to FIG. 1A, the power points 19 are located at various locations of the working machine 100, and in this particular example include a front power point, a mid power point, and rear power points. Other examples may have more, or fewer, power points, which may be provided at various locations on a working vehicle or other working machine. The working machine 100 has modular electric accessories 31 and 32 coupled to (e.g., plugged into) the power points 19. A working machine platform 11, which may include a chassis or other frame (e.g., a vehicle chassis in some embodiments) having other components mounted thereon (e.g., the power points 19, the electric system 15, etc.), may also be referred to herein as a frame assembly herein.

The electric accessories 31 and 32 are modular in the sense that they may be de-coupled from a power point 19 (e.g., unplugged), and then coupled to a similar power point of another working machine (not shown), or coupled to a different power point 19 of the same working machine 100 (where the location/implement combination is determined to be a valid by an intelligent control system (e.g., a supervising module) of the working machine 100, which may control operations of the accessories 31 and 32, in some embodiments).

In the illustrated example, the modular electric accessories 31 and 32 include a linear, rotational, or fluid power transfer system (e.g., selective control valves unit, or SCV), a rotational power transfer system (e.g., a power take off unit, or PTO), and a power actuated hitch (e.g., a hydraulic hitch). However, these are examples of possible electric accessories that may be used with the power points 19, and are not meant to be limiting. In various embodiments, the power points 19 may be arranged to operate with a plugged in one of a wide variety of modular electric accessories, including but not limited to electric components that may operate as part of one or more powered implements and/or a transportation system of the working machine 100. In various embodiments, modular electric accessories can include a self-contained PTO, a self-contained hydraulic SCV system (for hydraulic actuation control off-board a working vehicle, such as with a towed implement), a self-contained hydraulic power beyond system (for hydraulic valves which are on-board a working machine already, like a 3 pt hitch), or the like, or combinations thereof.

The modular nature of the power points 19 may meet a need for increased flexibility and cost reduction for working machine platforms. For instance, a working machine platform (e.g., any frame assembly described herein) may be designed in a way to allow various powertrain options to be easily added to the platform (e.g., to the frame assembly) post factory shipment. The working machine platform may be designed with mechanical and electrical ports (e.g., power points 19) for adding powered implements and/or transportation devices. Electric powertrain devices of working machines may be designed in a way to fit a wide range of functional use cases where speeds and load may vary greatly (based on which devices are plugged into the power points 19). Incorporation of machine controller intelligence with software and embedded computational hardware, can further increase the use case flexibility of electric powertrain components.

In various embodiments, the working machine 100 may be a pure electric vehicle, but this may not be required in other embodiments. In some embodiments, it may be possible to provide a “hybrid” working machine, in which a transportation system of the hybrid working machine may be powered by an electric motor and a mechanical engine. In other embodiments, a working machine may have a mechanical engine for the transportation system, and an electric motor for one or more integral electrically-powered implements. In any of these cases, the power points 19 may be coupled to a power source of the electric system 15 (e.g., a battery) or some other shared component of the electric system 15.

Referring now to FIG. 1B, the power point 19 may include a mechanical chassis connection 51. The mechanical chassis connection 51 may include any load support components and fastening components now known or later developed. The mechanical chassis connection 51 may stabilize a mounting of the accessories 31 and 32 on the frame assembly to provide reliable operation of a communication connection 52, and power connections 53 and 54 during operation of the working machine 100.

The working machine platform 11 may include a hardware and software system (illustrated as circuitry 20 in FIG. 1B) to control operations of the at least one selectively-locatable electric accessory, as well as a transportation system and/or any integral powered implements of the working machine 100. This hardware and software system may communicate over a communication connection 52 of the power point 19. The communication connection 52 may include any wired and/or wireless connections between the modular electric accessories 31 and 32 and the circuitry 20. In various embodiments, a modular electric accessory 31 may include circuitry 70 for communication and control of integral electrical and/or integral mechanical devices of the electric accessory 31, which may operate under the control of signaling originating from the circuitry 20 of the working machine 100. In various embodiments, any circuitry described herein may include an application-specific processor for performing any operations described herein, and/or a general purpose processor to execute instructions stored on a memory for performing any operations described herein.

The power point 19 may also include a connection to provide power to the control circuitry of the accessory (e.g., a low voltage power connection 53). The power point 19 may also include a connection to provide power to the working devices (e.g., a high voltage power connection 54 to provide power to accessory working devices, such as an actuator, a transportation system component, a powered implement component, or the like, or combinations thereof).

Referring now to FIG. 1C, any accessory to couple to the power point 19 may include one of more of the illustrated example components. Accessory 31 may embedded electronics 70 (e.g., a motor micro controller 71 or other the control circuitry that may operate under the control of control signaling originating from a hardware and software system of the working machine 100, and which may also control of electrical and/or mechanical devices integral with the accessory 31).

The communication connection 72, and the power connections 73 and 74 may be similar in any respect to communication connection 52 (FIG. 1B) and the power connections 53 and 54 (FIG. 1B), respectively. The mechanical chassis connection 61 may mate with the mechanical chassis connection 51 (FIG. 1B). In the illustrated embodiment, in which the accessory 31 is a PTO accessory, the accessory 31 may include an electric motor 62, a gear reduction 63, and a PTO shaft 64 (which may be similar to any PTO shaft, now known or later developed).

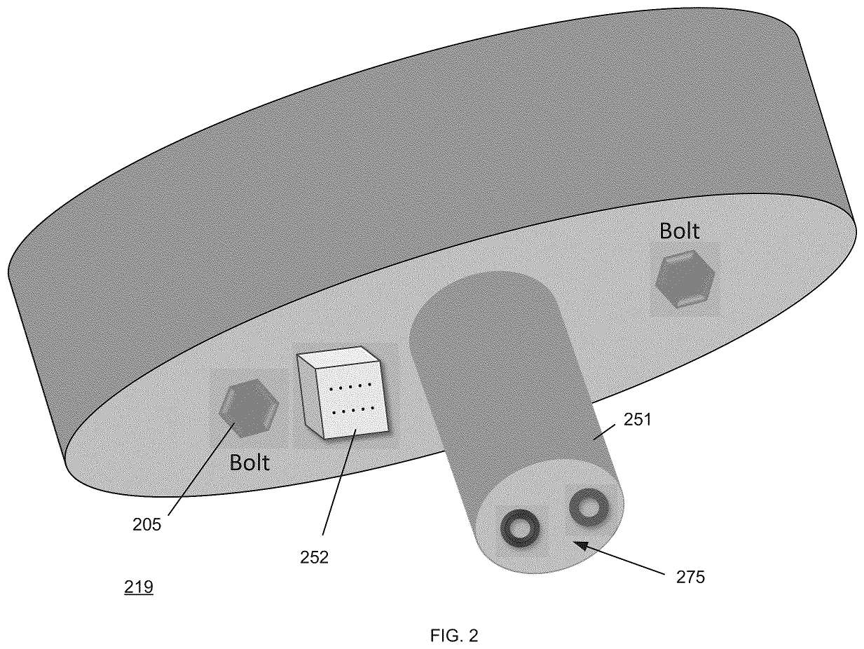

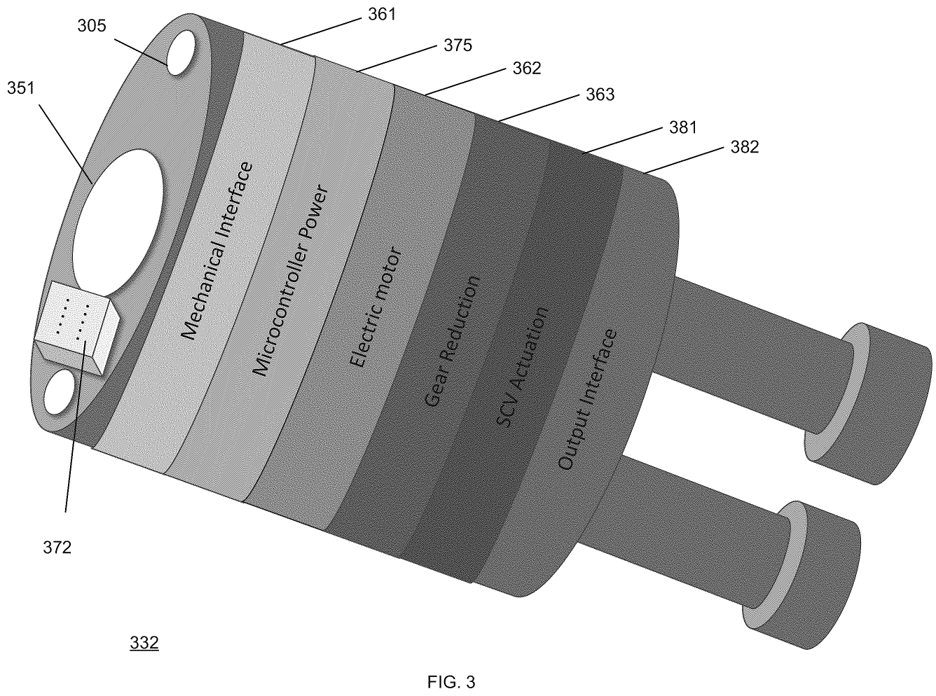

FIG. 2 is a schematic view of another power point 219, according to various embodiments. FIG. 3 is a schematic view of a modularized electric accessory 332 usable with the power point of FIG. 2. This power point 219 may be similar in any respect to power point 19 (FIG. 1A), or any other power point described herein, and this modularized electric accessory 332 may be similar in any respect to accessory 32 (FIG. 1A) or any other accessory described herein.

In this embodiment, a shaft 251 to mate with an opening 351 provides a load support for the accessory 332 coupled to a working machine. Bolts 205 are part of a fastening system to affix a rotational position of the accessory 332 on the load support. By using bolts 205 or a similar fastening system, the accessory 332 may be removably attached to the power point 219—in which the accessory 332 may be attached/removed without any permanent deforming any parts of an assembly of the power point 219 and/or the accessory 332. In any removable attachable embodiments, it may be possible to use any quick release system now known or later developed to perform one or both of the load support and fastening functions. Removably attachment is not required (in other examples, the accessory 332 may be fixably installed to the power point 219 in which the fastening system may need to be replaced/repaired following an attachment or removal, e.g., by welding, by riveting, or the like, or combinations thereof).

In this embodiment, an output 275 to power a working device of the accessory 332 (e.g., a high voltage power output) is located on the end of the shaft 251; however, in other embodiments the output 275 may be separate from a load support component. One or more connectors 252 may provide an output to power the circuitry of the accessory (e.g., a low voltage power output), and may also provide a communication connection similar to any communication connection described herein (e.g., one or more lines for the bi-directional exchange of digital signals).

Referring now to FIG. 3, the accessory 332 may include a mechanical interface 361 including the opening 351 (or some other load support component to mate with a load support component of the power point 219). The mechanical interface 361 may also include female or male attachment interface 305 to mate with a male or female attachment interface of the power point (e.g., nuts or some other fastener to mate with the bolts/fasteners 205).

One or more connectors 372 may mate with the one or more connectors 252, and may provide microcontroller power 375 (e.g., power to a microcontroller or some other processing device of the circuitry of the accessory 332). The microcontroller or other processing device may communicate with software or hardware of the working machine via the connector 372, or some other connector in various embodiments.

An electric motor 362 may receive power from the output 275 (FIG. 2), and may drive an actuator of the assembly (e.g., SCV actuation 381). An output interface 382 for mounting a task-specific attachment (e.g., a working part of a powered implement) may include a linear, rotational, or fluid power transfer system that may drive operation of the mounted task-specific attachment (this embodiment illustrates a hydraulic SCV). A gear train 363 may be similar to any gear train, now known or later developed.

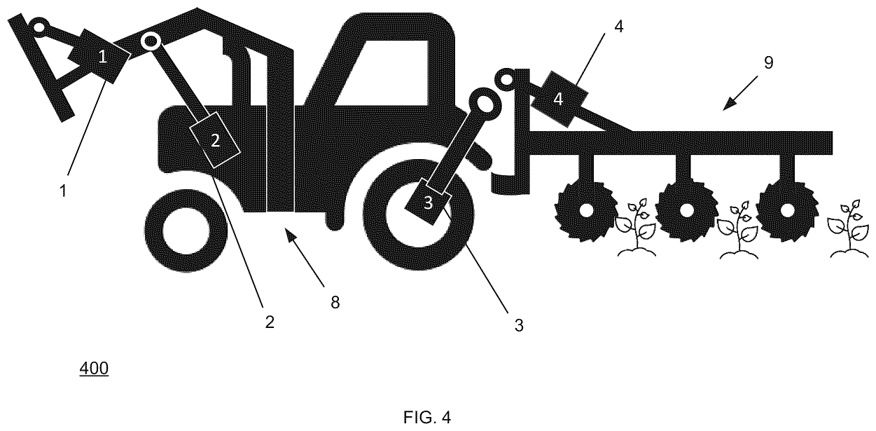

In some embodiments, a power accessory similar in any respect to any accessory described herein may be an actuator, which may include a motor, mechanical interfaces, electrical interfaces, and communication systems. Such accessories may be installed on a configurable chassis as stand-alone work units or in combination to form a more complex drive train system. FIG. 4 is a schematic view of an embodiment in which the power accessories are actuators.

Referring to FIG. 4, a working vehicle 400 may include a tractor 8 and/or a towed implement 9, and may include a plurality of power points similar to any power points described herein. The power points may output power from a single power source, or a set of power sources (which may be distributed as desired on the working vehicle 400).

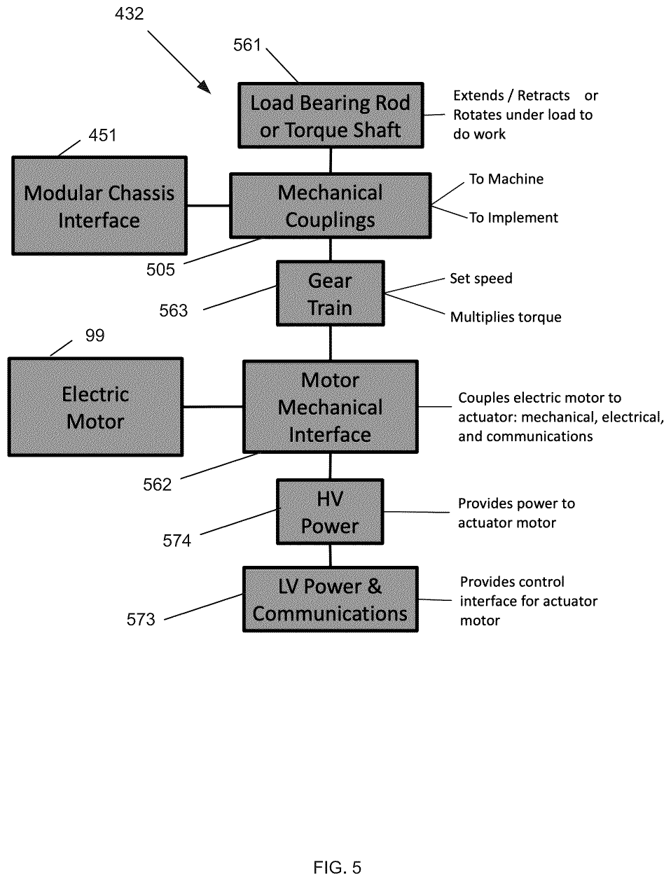

The working vehicle 400 may include an electric motor 99 (FIG. 5), which may be part of a transportation system of the working vehicle 400 or some other powered system of the working vehicle 400 in various embodiments. Each power point of the working vehicle may include a modular chassis interface 451 (which may be similar in any respect to any modular chassis connection described herein, such as modular chassis connection 51 of FIG. 1B).

Referring again to FIG. 4, in various embodiments, a set of actuators of the tractor 8 and towed implement 9 (illustrated as actuators 1-4) may utilize a same component of the working vehicle 400, e.g., a motor drive of the electric motor 99 (FIG. 5) the working vehicle 400. In this embodiment, a frame assembly of the working vehicle 400 may include the electric motor 99 (FIG. 5) including the motor drive. Actuators within accessories coupled to (e.g., plugged into) power points of the working vehicle 400 may receive electrical and/or mechanical power over the power points.

FIG. 5 is a schematic view of various components of the working machine 400 of FIG. 4. A motor mechanical interface 562 may couple mechanically couple the actuator 432 (e.g., the actuator motor) to an electric motor 99 of the working vehicle 400 (e.g., the motor drive). HV power 574 and LV power & communication 573 may be similar to any high voltage power, low voltage power, and communication connection described herein.

An actuator output 561 (e.g., a load bearing rod or torque shaft) may have a task-specific attachment coupled thereto (not shown). Mechanical couplings 505 may include a mechanical and/or electric coupling to a modular chassis interface 451 of the power point (which may be similar in any respect to the mechanical chassis connection 51 of FIG. 1B). Mechanical couplings 505 may couple the actuator output to a gear train 563 (which may be any gear train now known or later developed).

### Tractor Using Power Points

Known off-highway vehicles may be designed and manufactured to have a specific set of functionality which may not be alterable post introduction of the vehicle to the supply chain (e.g., post-delivery of the vehicle to a dealer or customer). Known vehicles may come ready to work including hydraulic actuator and PTO connection points to allow for the customer to add a variety of task-specific attachments; but the powertrain on the machine and its connections may be fixed.

Some known compact tractors may include a rear PTO, a rear hydraulic lift hitch (e.g., a 3-point or 2-point, and one to three hydraulic power connections (e.g., SCV's). Popular factory options for these vehicles may include a front PTO, mid-chassis PTO, front hydraulic lift hitch (3-point or 2-point hitch), front bucket loader with lift and bucket actuation, and rear excavator with boom, stick, and bucket actuation. Many of these factory options are difficult and expensive, if not impossible, to add to a machine post factory shipment, so the dealer/customer must carefully plan how the vehicle will be used prior to ordering. As machines migrate to EV platforms, it may become cost prohibitive to dedicate electric drivetrain components to all vehicle options previously listed.

A compact tractor or other working machine employing any of the features described herein may have variously located power points similar to any power points described herein. This may allow a front, rear, and mid-chassis PTO application using a single modular electric PTO that can be moved to the location on the EV platform where the work is needed, given that most applications do not need more than one PTO component for a given task.

Similarly, the main power component needed for linear actuators, an electric motor, could be designed in a modular way to move between front loader applications, hitch applications, and excavator applications. Often more than one linear actuator may be needed for a given task, but the total number for a given vehicle and set of attachments may be reduced given a modular design. FIG. 3 illustrates one embodiment of an accessory 332, which includes an electric motor 362 and an output interface 382 to receive any attachment of a set of attachments. As described with reference to FIG. 1A, this accessory 332 can be used at different locations (e.g., different power points) on the working machine.

### Modular Drivetrain

Whereas some other embodiments described herein may include a modular front axle that includes electric motors, other embodiments may include a completely modular, electric, transportation system (e.g., ground-drive system). This may allow a working machine to be configured with transportation devices (e.g., wheels/tires) of different heights and widths depending on application, work site conditions (e.g., crop conditions), or user preference.

In addition to multiple transport wheel/tire configurations, the transportation system could also allow for tracked vehicle configuration (two tracks or four). Some known drivetrains may not feasibly support change from a 4-wheel system to a 2-track system because of the principles of motion control and steering may be vastly different. However, using electric motors to transmit power may allow the motion control principles to be accommodated in software.

In various embodiments of a modular drivetrain, the system may include:
A chassis—a machine frame that has configurable mounting locations spaced horizontally along both sides that would allow for fastening transportation devices (e.g., ground drive components such as electrically driven axles) to be mounted.
Vertical axle mounts—installable to the chassis on each side, horizontally spaced to achieve a desired wheel-base. The vertical axle mounts may provide installation locations for electrically driven axles or wheel motors at multiple vertical locations, which allows for vehicle ride height configuration and accommodation of different transportation devices (e.g., ground-drive components such as wheels or tracks).
Frame assembly components—various components that, together with the chassis, provide a frame assembly similar in any respect to any frame assembly described herein. These components may be mounted on the chassis, and may include the power supply and control system for the working machine, such as a battery pack, inverter, control ECU, wiring, etc. A frame assembly electrical system (coupled to the chassis) may allow for transportation devices (e.g., ground drive devices) to plug into standardized connectors at various locations so that wheelbase and ride height options are not restricted. Wiring harness extensions could be considered to cover edge-case configuration of very long or very wide transportation device spacing. A frame assembly wiring architecture may support high-voltage, low-voltage, and communication lines for connecting each transportation device (e.g., ground drive component).
Drive axles—drive axles with electric motors may be mounted to the axle mounts in the desired positions and subsequently mounted to the frame assembly. Drive axles may be as simple as electric motors with a mechanical housing for working machines that only require differential steering (like a CTL, dozer, or other track-driven working machines). In other embodiments, they may be more complex assemblies that include individual steering motors and suspension systems. Some drive axles may be configured as an entire undercarriage such as the case of a two-track working machine where two drive motors are needed, bogie wheels, and tensioning system.

In various embodiments, a transportation system of a working machine may include a drivetrain including a modular power axle assembly or a power spindle. At least part of the drivetrain may be coupled to a mechanical load support of a power point. In embodiments with a drivetrain including a modular power axle assembly, the transportation system may include two powered transportation devices (e.g., wheels) coupled together, and which may be driven by a single power supply (motor) or with dedicated power supplies to each. In other embodiments with a power spindle, a single transport device assembly (e.g., a single powered wheel assembly) may be used at each corner of a four-device transportation system (e.g., a working machine having a 4-wheel configuration).

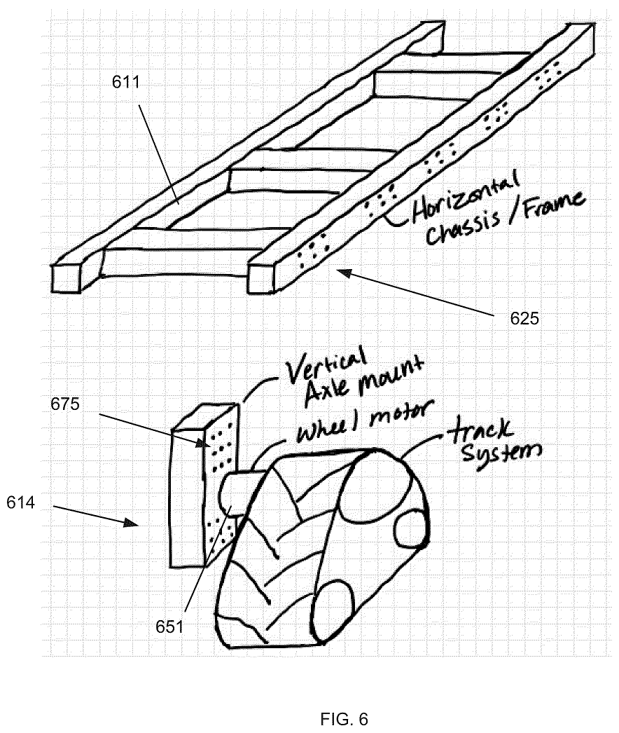

FIG. 6 is a schematic view of a chassis 611 and a transportation device 614 for a modular drivetrain, according to various embodiments. The chassis 611 may be similar to any chassis described herein. The configurable mounting locations 625 are spaced horizontally along a horizontal member of the chassis 611.

The transportation device 614 includes a vertical axle mount, which may be similar to any vertical axle mount described herein. Configurable mounting locations 675 on the vertical axle mount are variously alignable with the configurable mounting locations 625 to provide vehicle ride height configuration and accommodation of different transportation devices.

A frame assembly that includes the chassis may define a plurality of power points. The transportation device motor 651 may be coupled to a selected power point of the power points at its selected horizontal/vertical position.

### Working Machine with Front Wheel Assist and/or Powered Implement Assist

Some off-highway vehicles may be designed with either a rear wheel drive configuration or an optional four wheel drive with a powered front axle that is mechanically coupled to the transmission. The front wheel drive may increase the mechanical complexity of the drive train system. Various embodiments of a working machine may include a modular front axle that may include the electric drive actuation and also the electric drive for steering such that a tractor chassis can be easily configuration at a point of sale rather than at a factory.

Working machines may be commonly used to pull implements for a work task. The size of the tractor or other towing working machine may be dictated by the size of the pulled implement (e.g., requiring a minimum power or weight to support power transfer to support drawbar load requirements from the pulled implement). Some implements are towed with transportation devices (e.g., wheels) to support carrying for transport and, in some cases, managing the implement height or depth needs. Any of the features described herein may allow those implement transportation devices to be used to augment power transfer to the ground by incorporating electric drives. This may allow narrow tractors to be used in areas with width constraints, or support reduced tractor size for operations that may only require a small fraction of the towing working machine's lifecycle.

### Examples

Various embodiments using any of the features described herein may include a working machine platform with an EV powertrain and modular auxiliary power points (e.g., work ports) for PTO and actuator connection (mechanical and electric ports).

Various embodiments using any of the features described herein may include a modular EV powertrain component to accomplish PTO related work and attachment connections.

Various embodiments using any of the features described herein may include a modular EV powertrain component to accomplish linear actuator related work and attachment connection.

Various embodiments using any of the features described herein may include an intelligent machine control system for managing modular EV powertrain components through a wide range of applications and use cases.

Various embodiments using any of the features described herein may include a modular EV powertrain component to allow point of sale customization of a transportation system through front wheel power addition.

Various embodiments using any of the features described herein may include a modular EV powertrain component to allow implement drive power at the wheel of a towing working machine.

In any embodiment described herein one or more components of an electric motor may be shared by a plurality of accessories using any power point described herein. Shared components may include any electric motor components such as a motor (or any of its components, such as windings, magnets, stator, bearings, etc.), an inverter, controllers, battery pack, etc.

In view of the many possible embodiments to which the principles of the disclosed technology may be applied, it should be recognized that the illustrated embodiments are only preferred examples and should not be taken as limiting the scope of the disclosure.

1. An apparatus, comprising:
a working machine including a transportation system and one or more implements to perform one or more work tasks, the working machine further including:
at least one selectively-locatable electric accessory, which comprises at least part of the transportation system or at least part of a powered implement of the one or more implements, the at least one selectively-locatable electric accessory defining a first mechanical frame connection;
a frame assembly including two or more power points at two or more different locations on the frame assembly, respectively;
wherein each power point defines a second mechanical frame connection to mate with the first mechanical frame connection, and wherein the at least one selectively-locatable electric accessory is operable in any of the two or more power points.

2. The apparatus of claim 1, wherein at least one of the two or more different locations on the frame assembly corresponds to a front section of the working machine, a rear section of the working machine, or section between the front and rear sections.

3. The apparatus of claim 1, wherein the at least one selectively-locatable electric accessory comprises a power take off (PTO) system or other rotational power transfer system of the working machine.

4. The apparatus of claim 1, wherein the at least one selectively-locatable electric accessory comprises a selective control valve (SCV) system or other linear, rotational, or fluid power transfer system of the working machine.

5. The apparatus of claim 1, wherein the at least one selectively-locatable electric accessory comprises a power actuated hitch.

6. The apparatus of claim 1, wherein the at least one selectively-locatable electric accessory comprises part of a drivetrain of the transportation system.

7. The apparatus of claim 1, wherein the transportation system further comprises a drivetrain, wherein at least part of the drivetrain is coupled to the working machine via the first and second mechanical load supports.

8. The apparatus of claim 7, wherein the at least part of the drivetrain comprises a modular power axle assembly or power spindle.

9. The apparatus of claim 1, wherein the working machine comprises a tractor and towed implement, the tractor comprising the power points, and the towed implement includes one or more additional power points.

10. The apparatus of claim 9, further comprising a powered implement assist coupled to an additional power point of the one or more additional power points.

11. The apparatus of claim 1, wherein the at least one selectively-locatable electric accessory includes circuitry for communication and control of electrical and/or mechanical devices of the selectively-locatable electric accessory;
the working machine further comprising a hardware and software system to control operations of the transportation system, the powered implement, or the at least one selectively-locatable electric accessory.

12. The apparatus of claim 11, wherein each power point further comprises a communication connection over which the hardware and software system communicates with the circuitry to control the operations.

13. The apparatus of claim 11, wherein the at least one selectively-locatable accessory comprises two or more selectively-locatable accessories, and in which the two or more selectively-locatable accessories are coupled to a same resource of an electric system of the frame assembly via the power points.

14. The apparatus of claim 13, wherein the resource comprises a power source.

15. The apparatus of claim 13, wherein the resource comprises at least one motor drive, and wherein the two or more selectively-locatable accessories include two or more actuators, respectively.

16. An apparatus, comprising:
at least one selectively-locatable electric accessory to operate as part of a transportation system of a working machine or at least part of a powered implement of the one or more implements of the working machine;
the at least one selectively-locatable electric accessory defining a first mechanical frame connection to plug into any of two or more second mechanical frame connections of two or more power points, respectively, of the working machine;
wherein the at least one selectively-locatable electric accessory is operable in any of the two or more power points.

17. The apparatus of claim 16, wherein the at least one selectively-locatable electric accessory comprises a power take off (PTO) system or other rotational power transfer system.

18. The apparatus of claim 16, wherein the at least one selectively-locatable electric accessory comprises a selective control valve (SCV) system or other linear, rotational, or fluid power transfer system.

19. The apparatus of claim 16, wherein the at least one selectively-locatable electric accessory comprises a power actuated hitch.

20. The apparatus of claim 16, wherein the at least one selectively-locatable accessory is arranged to, when plugged into any of the two or more power points, consume electrical or mechanical power output from a resource of an electric system of the working machine to operate via a corresponding one of the power points.
